(19) United States
(12) Patent Application Publication
(10) Pub. No.: US 2011/0091370 A1
(43) Pub. Date: Apr. 21, 2011

(54) Mechanochemical Synthesis of Carbon Fluorides and an Electrochemical Cell using the Synthesized Carbon Fluorides

(75) Inventors: Wishvender K. Behl, Olney, MD (US); Jeffrey A. Read, West Friendship, MD (US)

(73) Assignee: U.S. Government as represented by the Secretary of the Army, Adelphi, MD (US)

(21) Appl. No.: 12/877,153

(22) Filed: Sep. 8, 2010

Related U.S. Application Data
(60) Provisional application No. 61/251,843, filed on Oct. 15, 2009.

(51) Int. Cl. C01B 31/00

(52) U.S. Cl. 423/439

(57) ABSTRACT

Carbon fluoride is synthesized by reactively or high intensity/energy milling at ambient room temperature carbon-containing material (such as graphite, carbon black, coke, or other carbon-based material) with an inorganic fluoride agent (such as cobalt trifluoride) other than fluorine gas. The following chemical reaction occurs: xC+CoF₃→CₓF+CoF₂, wherein x equals 1 to 4. The CₓF is separated from the CoF₂ and the CoF₃ by digesting the CₓF, CoF₂ and the CoF₃ in hot water of at least approximately 90° C. causing the CoF₂ to dissolve; and then filtering the CoF₂. The CoF₃ is unreacted and undergoes hydrolysis in the hot water to form Co(OH)₃ or Co₂O₃.3H₂O, which is removed by washing with sulfuric acid. Alternatively, the CₓF is separated from the CoF₂ and the CoF₃ by digesting the CₓF, CoF₂ and the CoF₃ in heated sulfuric acid followed by filtration and washing with sulfuric acid and then with hot water. The synthesized carbon fluoride is used to form a cathode in electrochemical cells, such as lithium batteries.

### CROSS REFERENCE TO RELATED APPLICATION

This application claims the benefit of U.S. Provisional Patent Application No. 61/251,843 filed on Oct. 15, 2009, the complete disclosure of which, in its entirety, is herein incorporated by reference.

### GOVERNMENT INTEREST

The embodiments herein may be manufactured, used, sold, imported and/or licensed by or for the United States Government without the payment of royalties thereon.

### BACKGROUND

1. Technical Field

The embodiments herein generally relate to the synthesis of carbon fluorides, and, more particularly, to a mechanochemical synthesis of carbon fluorides.

2. Description of the Related Art

The synthesis of carbon fluoride materials (CₓF), where x varies from 1 to 4 is typically accomplished using standard chemical reactions between carbon and a fluorine source, with time, temperature, and reactant concentration being the variables of interest. Electrochemical synthesis has also been used, but is less common method for production of these materials. Carbon fluoride materials can be divided into two classes depending on whether the C—F bond is semi-ionic or covalent. The nature of the C—F bond is determined mainly by synthesis temperature and choice of fluorine source.

Carbon fluorides prepared by the direct reaction of carbon with elemental fluorine at temperatures of 350° C. to 640° C. are characterized by covalent C—F bonds with sp³ hybridized carbon. In the case of graphite precursors, the carbon sheet is converted from a planar sheet structure to a puckered arrangement. The ratio of carbon to fluorine is controlled by the choice of carbon precursor, time, temperature, and fluorine partial pressure. These materials, generally referred to as high temperature carbon fluorides (HT CF), have been used as cathode materials in non-aqueous primary lithium batteries and demonstrate excellent discharge and storage properties.

Carbon fluorides prepared at low temperature (20-100° C.), generally referred to as low temperature carbon fluorides (LT CF), are characterized by semi-ionic C—F bonds and sp² hybridized carbon. In the case of graphite precursors, the carbon sheet retains its planar structure. A number of different methods have been used to prepare LT CF, with most of the methods involving the reaction of graphite with F₂ gas in the presence of HF or another Lewis acid. C₄F has been synthesized using F₂ and HF, while CₓF_{1-δ}(HF)_{δ} (2≦x≦5 and x/δ≅12) has been synthesized using F₂ (2 atm) and liquid HF for x≅2. CₓF with x<2 has been synthesized by first preparing the graphite salt (graphite)⁺AsF₆⁻ from AsF₅, followed by treatment with F₂ and HF to obtain the final product. CₓF with x=1.2 has been synthesized using complex fluorides such as KAgF₄ dissolved in anhydrous HF under pressurized F₂ gas. The preparation of carbon fluorides at low temperature without the use of gaseous F₂ has been demonstrated using transition fluorometallates such as K₂MnF₆ dissolved in anhydrous HF. These LT CF materials often contain residual amounts of HF or reaction products that are hard to remove from the final carbon fluoride powder.

### SUMMARY

In view of the foregoing, an embodiment herein provides a method of synthesizing carbon fluoride material, wherein the method comprises providing a carbon-containing material; and reactively or high energy/intensity milling at ambient room temperature the carbon-containing material with an inorganic fluoride agent other than fluorine gas to form a carbon fluoride material. The carbon-containing material may be graphite, carbon black, coke, or other carbon-based material. The inorganic fluoride agent may be cobalt trifluoride, wherein the method may further comprise reactively milling the carbon-containing material with the cobalt trifluoride to create a chemical reaction comprising: xC+CoF₃→CₓF+CoF₂, wherein x comprises a value from 1 to 4. In one embodiment, the method may further comprise separating the CₓF from the CoF₂ and the unreacted CoF₃ by digesting the mixture CₓF, CoF₂ and the CoF₃ in hot water of at least approximately 90° C. causing the CoF₂ to dissolve in the hot water; and removing the CoF₂ by filtration. The unreacted CoF₃ undergoes hydrolysis in the hot water to form Co(OH)₃ or Co₂O₃.3H₂O, which is removed by digesting the mixture with 1 molar (M) sulfuric acid followed by filtration and washing with hot water. Alternatively, the method may further comprise separating the CₓF from the CoF₂ and the CoF₃ by digesting the mixture in heated 1M sulfuric acid; filtering the digested mixture and washing with 1M sulfuric acid, followed by washing with hot water.

Another embodiment provides a method of creating an electrochemical cell, wherein the method comprises synthesizing carbon fluoride material by reactively or high intensity/energy milling at ambient room temperature a carbon-containing material with an inorganic fluoride agent other than fluorine gas; and using the synthesized carbon fluoride material as a cathode material in an electrochemical cell. The carbon-containing material may be graphite, carbon black, coke or other carbon-based material and the inorganic fluoride agent may be cobalt trifluoride. The reactively or high intensity/energy milling is a chemical reaction comprising: xC+CoF₃→CₓF+CoF₂, wherein x comprises a value from 1 to 4. In one embodiment, the method may further comprise separating the CₓF from the CoF₂ and the unreacted CoF₃ by digesting the mixture CₓF, CoF₂ and the CoF₃ in hot water causing the CoF₂ to dissolve and removing the CoF₂ by filtration. The unreacted CoF₃ undergoes hydrolysis in the hot water to form Co(OH)₃ or Co₂O₃.3H₂O, which is removed by digesting the mixture with 1 M sulfuric acid followed by filtration and washing with hot water. Alternatively, the method may further comprise separating the CₓF from the CoF₂ and the CoF₃ by digesting the mixture in heated 1M sulfuric acid; filtering the digested mixture and washing with 1M sulfuric acid, followed by washing with hot water.

Another embodiment provides an electrochemical cell comprising carbon fluoride material synthesized as described above.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates powder X-ray diffraction graphs of (A) synthesized carbon fluoride according to the embodiments described herein and (B) commercial HT CF prepared from graphite;

FIG. 2 illustrates IR spectrum graphs of (A) synthesized carbon fluoride powder according to the embodiments described herein and (B) commercial HT CF prepared from graphite;

FIGS. 3A and 3B illustrate XPS spectrum graphs of synthesized carbon fluoride powder according to the embodiments described herein;

FIG. 4 illustrates graphs of the specific capacity vs. voltage of (A) synthesized carbon fluoride powder according to the embodiments described herein and (B) commercial HT CF prepared from graphite; and

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

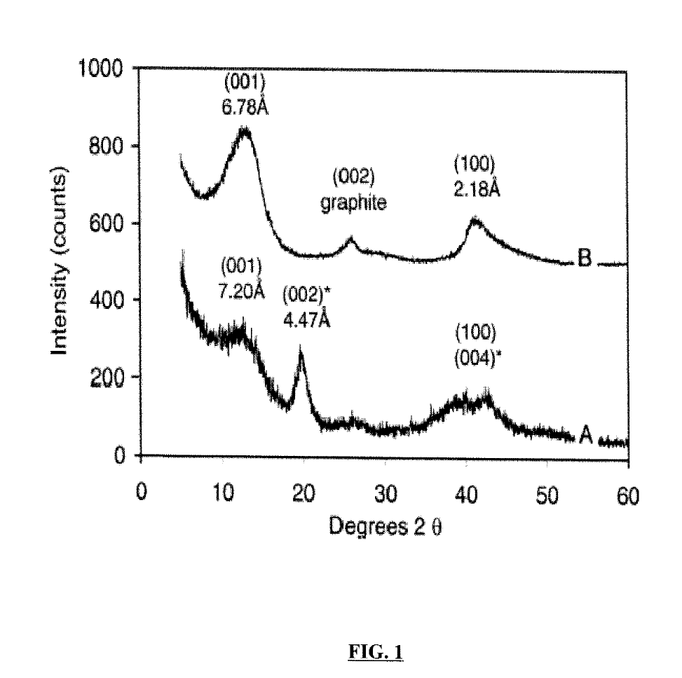

The embodiments herein provide a technique of synthesizing carbon fluoride by mixing carbon or graphite or other carbon-containing material with an inorganic fluoride agent such as cobalt trifluoride, lead fluoride (PbF₄), bismuth fluoride (BiF₅), antimony fluoride (SbF₅), silver fluoride (AgF & AgF₂), KAgF₄, K2NiF₆, K₂MnF₆, and Na₃FeF₆. The mixture is then subjected to a high energy milling process such that, for example, the cobalt trifluoride reacts with carbon to form carbon fluoride and in the process is reduced to cobalt difluoride. Referring now to the drawings, and more particularly to FIGS. 1 through 4, where similar reference characters denote corresponding features consistently throughout the figures, there are shown preferred embodiments.

The embodiments herein provide a novel technique for synthesizing carbon fluorides at room temperature that takes advantage of the reaction between graphite and CoF₃ (Equation 1) being thermodynamically favored at room temperature.

xC+CoF₃→CₓF+CoF₂ (1)

The free energy change for the reaction in Equation 1 is calculated from the thermodynamic data to be −55.6 KJ/mole of CoF₃ for x=1. The reaction, although thermodynamically favored at room temperature, does not occur unless the two solid reactants are brought into intimate contact.

Conventional efforts by others considered the possibility of a reaction between FeF₃ and carbon to form CₓF and FeF₂ during the high energy milling of these materials but there was no evidence that a reaction occurs. Based on thermodynamic considerations, none is expected. In fact, the conventional efforts demonstrate that the reverse reaction between CF₁ and FeF₂ to form FeF₃ does occur under high intensity milling with the reaction going to near completion after approximately 6 hours. Other conventional efforts studied the same reaction between FeF₃ and carbon using high intensity milling and proposed that CₓF compounds did form after approximately 24 hours of milling. The X-ray diffraction data, however, is not conclusive and no additional analysis was undertaken to demonstrate the existence of a carbon fluoride product in the milled powders.

According to another embodiment herein, a method of separating carbon fluoride from the by-products is provided, wherein the product of high intensity/energy milling of carbon-containing material with CoF₃ comprises CₓF, CoF₂, and unreacted CoF₃. In order to separate CₓF from CoF₂ and CoF₃, the product is digested with distilled water on a heat source for approximately 1-2 hours. Cobalt difluoride dissolves in hot water and is removed by filtration. The unreacted cobalt trifluoride undergoes hydrolysis in water to form Co(OH)₃ or Co₂O₃.3H₂O, which is sparingly soluble in water and is not removed by digestion with hot water in the previous step. It is, however, soluble in acids and is removed by treating and washing with 1M sulfuric acid. Experimentally, the two washing steps may be reversed and the reaction product obtained by high intensity/energy milling of carbon and cobalt trifluoride is digested with warm 1M sulfuric acid and followed by washing with hot water until the filtrate is clear and free of any pink color due to the cobalt difluoride. The residue is then dried in a vacuum oven at 70° C. for approximately 16 hours. The residue comprises carbon fluoride and can be verified by X-ray diffraction (XRD), infrared (IR) analysis, X-ray photoelectron spectroscopy (XPS), elemental analysis, and electrochemical techniques.

According to another embodiment herein, the prepared carbon fluoride material is used as cathode materials in low rate and moderate rate lithium primary batteries treatment. The material demonstrates a higher running voltage than conventional high temperature CₓF (HT C_{X}F).

### EXAMPLES

The following materials are used in accordance with the synthesizing techniques provided by the embodiments herein: CoF₃ (99%) and graphite powder (99.9%), which are available from Alfa Aesar, Massachusetts, USA; Super P carbon black available from MMM Carbon, Willebroek, Belgium; Kynar® 2801 PVdF polymer available from Arkema Inc., Pennsylvania, USA; dibutylphthalate (Aldrich 99%+); lithium foil available from FMC Lithium, North Carolina, USA; Celgard® 3401 battery separator available from Celgard, LLC, North Carolina, USA; propylene carbonate (PC, Ferro, electrolyte grade); 1,2-dimethoxyethane (DME, Ferro, electrolyte grade); and LiBF₄ (Stella). Carbon monofluoride may be obtained from Advanced Research Chemicals Inc., Oklahoma, USA.

A Spex CertiPrep® 8000-D mixing mill, available from SPEX CertiPrep Inc., New Jersey, USA, is used for high intensity/energy milling of graphite and CoF₃ mixtures. The graphite powder is milled for approximately one hour to reduce the particle size to −120 mesh and then vacuum dried at 100° C. for approximately 16 hours before use. The high energy milling of the graphite-CoF₃ mixtures is performed by charging the milling jar in an argon filled dry box with approximately 1.0 g of graphite (40 mole %), 14.5 g of CoF₃ (60 mole %) and 85 g of hardened steel balls. The sealed jar is removed from the dry box and placed on the mixing mill and milled for approximately three hours with approximately 30 minute cooling periods after each hour of milling. The milled mixture is digested in approximately 200-300 cm³ of hot water to dissolve the CoF₂ formed on reaction. The residue is recovered upon filtering with the initial filtrate being a dark pink color. This residue is then continuously washed with hot water (e.g., at least approximately 90° C.) until the filtrate is colorless. Any excess CoF₃ in the milled powder undergoes hydrolysis in water to form cobalt hydroxide [Co(OH)₃] which is insoluble in hot water and thus is not removed by this process. Co(OH)₃ is however soluble in acids and is removed by digesting the remaining residue in approximately 1M sulfuric acid followed by additional washing with hot water. The powder residue is dried under vacuum at approximately 70° C. for analysis.

Cathodes for coin cells are fabricated by mixing the as synthesized carbon fluoride powder with Super P, Kynar® 2801 available from Arkema Inc., Pennsylvania, USA, and dibutylphthalate in an acetone slurry and casting onto a glass plate. The cast films are laminated onto aluminum grids and extracted in methanol to remove the dibutylphthalate. The extracted film contains approximately 66% active material by weight. The cathodes are dried at approximately 105° C. under vacuum then built into 2035 coin cells with 1M LiBF₄ in PC:DME (1:1 by weight) electrolyte. Coin cells are discharged at room temperature on a Maccor Series 4000 tester, available from Maccor, Inc., Oklahoma, USA, at 25 mA/g. Powder X-ray diffraction is recorded from approximately 5-60° 2θ at 1°/min on a Rigaku Ultima III Diffractometer available from Rigaku Americas, Texas, USA. Thermogravimetric analysis is run under nitrogen from approximately 25-800° C. at approximately 10° C./min on a TGA 7 available from PerkinElmer, Massachusetts, USA. Infrared spectra are recorded from approximately 400-4000 cm⁻¹ on a Nicolet Magna 5-60 Fourier transform IR spectro-photometer using KBr pellets. XPS is measured on a PHI 5803 ESCA system available from Physical Electronics Inc., Minnesota, USA.

The black carbon fluoride powder, as determined by elemental analysis, contains 44.1 wt % carbon, 44.2 wt % fluorine, and 8.7 wt % cobalt resulting in a chemical formula of C_{1.6}F(Co_{0.06}). An atomic ratio of fluorine to cobalt of ˜17 indicates that most, if not all, of the fluorine is bound to carbon. The X-ray diffraction pattern of the carbon fluoride powder shown in FIG. 1 gives several characteristic diffraction lines seen in both HT CF (hkl) and C₂F (hkl)* materials. The broad peak at approximately 12.5° 2θ is characteristic of the (001) line seen in HT CF materials. The (001)* peak (not visible) for C₂F materials is normally at approximately 10° 2θ but is not seen in the XRD pattern. The peak at approximately 20° 2θ can be clearly assigned to the (002)* line seen in (C₂F)ₓ materials. The peak at approximately 26° 2θ is characteristic of graphite and is relatively weak in this material. The peaks around 40° 2θ can be assigned to the (100) and (100)* (not visible) lines of either HT CF or (C₂F), and the (004)* line of (C₂F)ₓ. The sharpest and most dominant peak appears to be the peak representing (C₂F)ₓ. The X-Ray pattern does not show the presence of any crystalline cobalt compounds. The diffraction pattern of a commercial HT CF material (B) prepared from graphite is shown for comparison. This pattern shows the characteristic peaks for a HT CF material as well as a small graphite peak at approximately 26° 2θ. The thermogravimetric analysis (TGA) of the carbon fluoride powder shows two major weight losses. There is a 42% loss that begins at approximately 300° C. and ends at approximately 550° C. and indicates a weak CF bond. A second 28% weight loss occurs from approximately 600° C. to 800° C. and is typical for covalent CF materials.

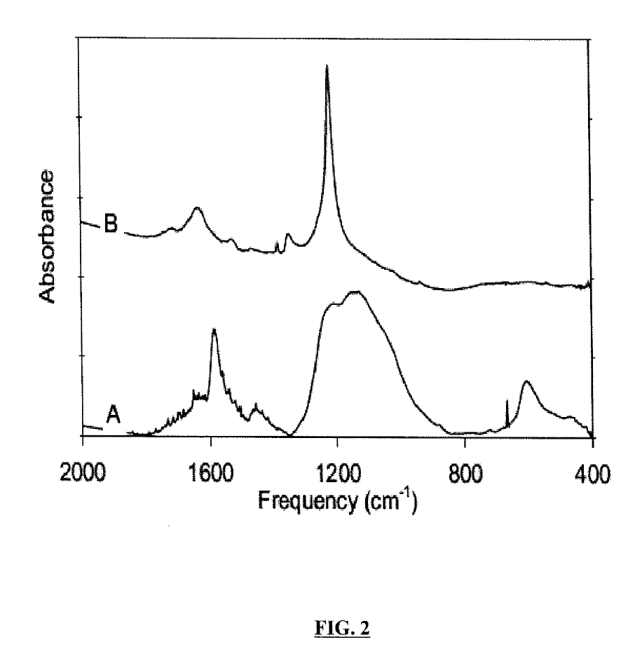

The IR spectrum of the synthesized carbon fluoride material (A) and that of a commercial covalent HT CF material (B) is shown in FIG. 2. The IR spectrum of the synthesized carbon fluoride material has been corrected by subtracting out the broad background absorbance typically seen in a black powder. The IR spectrum of the synthesized material has two broad overlapping peaks centered at approximately 1215 cm⁻¹ and 1145 cm⁻¹. The 1215 cm⁻¹ peak is close to that observed in covalent CF materials and indicates that some covalent CF bonds exist in the sample. The 1145 cm⁻¹ peak results from the significantly weaker semi-ionic CF bond and is similar to that seen in other low temperature CF materials. The IR spectrum also shows several other peaks not seen in covalently bonded CF materials. A peak at approximately 1585 cm⁻¹ is identified as a graphite-like band and supports the idea that sp² hybridized carbon is present in the sample. A peak at approximately 600 cm⁻¹ is similar to that seen in the spectrum of another conventional low temperature CF material that has been identified as belonging to an intercalated IF₅ molecule or IF₆⁻ ion.

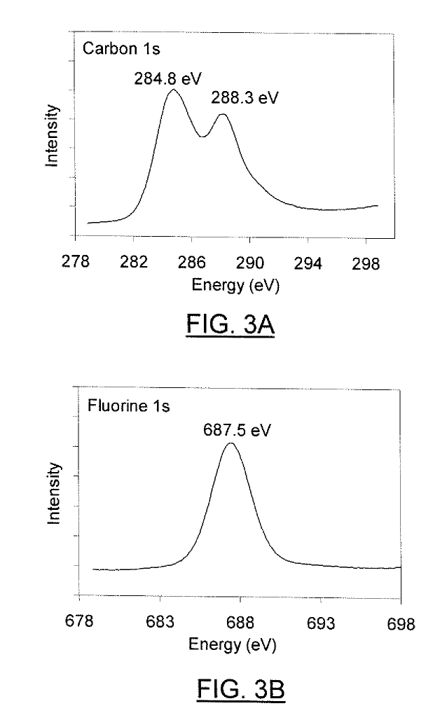

The XPS spectra of the synthesized carbon fluoride powder according to the invention is shown in FIGS. 3A and 3B. In FIG. 3A, the two carbon is peaks at approximately 284.8 eV and 288.3 eV are in line with XPS peak energies seen in other low temperature C₂F materials having semi-ionic CF bonds. In FIG. 3B, the broad fluorine is peak is centered at approximately 687.5 eV. The carbon fluoride powder does not show a peak in the range 689.3-689.6 eV, which would be expected for a covalently bonded C₂F material. The lack of a covalent CF peak in the XPS could mean that this material is inhomogeneous, with high fluorine content at the core of the particle and less near the surface. The atomic ratio of carbon to fluorine calculated from the XPS data is 2.4, significantly higher than the 1.6 ratio given by elemental analysis.

The X-ray, IR, and thermogravimetric analysis (TGA) data suggest a material that is a mixture of covalent CF and semi-ionic CF with an overall composition close to C_{1.6}F. The XPS data does not show evidence of covalently bonded CF, but since this is by nature a surface technique, it may not represent accurately the bulk sample. The residual cobalt in the final carbon fluoride is most likely cobalt sesquioxide [Co₂O₃], since Co(OH)₃ is converted to Co₂O₃ on heating, but the possibility that CoF₂ or CoF₃ imbedded within the particles are the source of cobalt cannot be ruled out. Given that no crystalline cobalt compounds are detectable by X-ray diffraction, the exact nature of the residual cobalt is not determined.

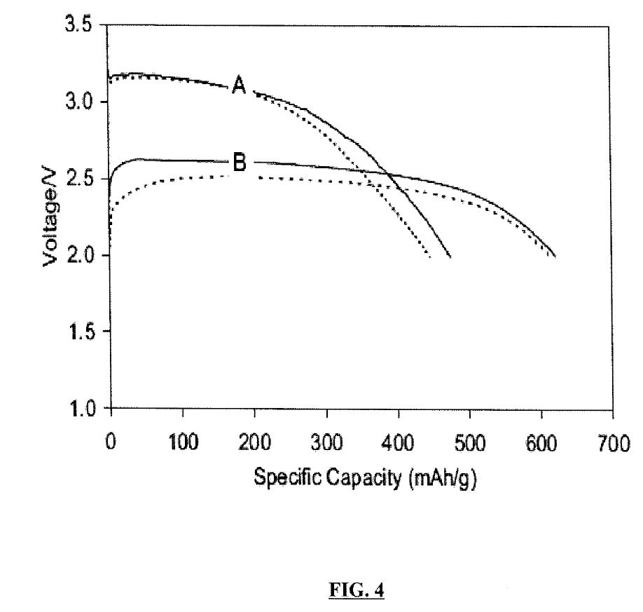

Discharge of the synthesized carbon fluoride powder (A) in lithium coin cells is shown in FIG. 4 with the solid curve at approximately 25 mA/g and the dashed curve at approximately 50 mA/g. This is compared to the discharge of a commercially available HT CF material prepared from graphite and F₂ at high temperature (B) with the solid curve at approximately 20 mA/g and the dashed curve at approximately 40 mA/g. The discharge voltage of the synthesized carbon fluoride powder is initially higher but slopes down more than the covalent HT CF. The synthesized carbon fluoride powder also shows a smaller voltage delay than the HT CF material but has a smaller discharge capacity of approximately 450-500 mAh/g. The sloping discharge curve is very similar to that seen in other low temperature CF materials as well as in some sub-fluorinated CₓF materials. The higher cell voltage, as compared to the HT CF, can be attributed to the lower overpotential expected when breaking semi-ionic C—F bonds during discharge. The sloping discharge may also be due to the inhomogeneous nature of the sample. Comparing discharges at the two rates, one can see that the polarization becomes more pronounced as discharge proceeds in the synthesized material while it remains fairly constant in the HT CF material. This could indicate that the synthesized material is a mixture that contains both covalent and semi-ionic CF. Given that the discharge potential of the synthesized material is higher than that of the commercial material for a majority of the discharge might indicate that the synthesized material has mainly semi-ionic C—F bonds. The discharge capacity of the synthesized material is comparable to the discharge capacity of the subfluorinated C_{1.6}F material.

The material formed from the simple high intensity milling of CoF₃ and graphite demonstrates many of the characteristics of a LT CF material without the use of F₂ gas, which is dangerous and difficult to handle. The cobalt is recovered in the process and can be reused.

The material prepared using this process has a composition of C_{1.6}F and appears to have both covalent and semi-ionic CF bonds. The TGA and electrochemical discharge indicate that a larger fraction of the carbon fluoride powder is semi-ionic in nature. The material provided by the embodiments herein has a high discharge potential of 3.2 V vs. Li/Li⁺ and a discharge capacity in the range of 450-500 mAh/g to 2.0 V.

An electrochemical cell using the carbon fluoride material produced according to the embodiments as a cathode material has a high open circuit and running voltage. The polarization typically seen in Li/CxF cells due to the difficulty in reducing CxF to C and LiF is greatly reduced in the material produced according to the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of synthesizing carbon fluoride material, said method comprising:
providing a carbon-containing material; and
high intensity milling said carbon-containing material at ambient room temperature with an inorganic fluoride agent other than fluorine gas to form said carbon fluoride material.

2. The method of claim 1, wherein said carbon-containing material comprises any of graphite, carbon black and coke.

3. The method of claim 1, wherein said inorganic fluoride agent comprises cobalt trifluoride to form CₓF and CoF₂, wherein x comprises a value from 1 to 4.

4. The method of claim 3, further comprising separating said CₓF from said CoF₂ and said CoF₃ by:
digesting said CₓF, CoF₂ and said CoF₃ in hot water causing said CoF₂ to dissolve in said hot water; and
removing said CoF₂ by filtration.

5. The method of claim 4, wherein said CoF₃ is unreacted and undergoes hydrolysis in said hot water to form any of Co(OH)₃ or Co₂O₃.3H₂O, which is then washed with sulfuric acid.

6. The method of claim 4, wherein the hot water is at least approximately 90° C.

7. The method of claim 3, further comprising separating said CₓF from said CoF₂ and said CoF₃ by:
digesting said CₓF, said CoF₂ and said CoF₃ in heated sulfuric acid;
filtering the digested said CₓF and said CoF₃; and
removing said CoF₂ and said CoF₃ by:
washing the filtered said CₓF, said CoF₂ and said CoF₃ with sulfuric acid; and
washing the filtered said CₓF, said CoF₂ and said CoF₃ with hot water.

8. A method of creating an electrochemical cell, said method comprising:
synthesizing carbon fluoride material by high intensity milling a carbon-containing material at ambient room temperature with an inorganic fluoride agent other than fluorine gas to form said carbon fluoride material; and
using the synthesized carbon fluoride material as cathode material in an electrochemical cell.

9. The method of claim 8, wherein said carbon-containing material comprises any of graphite, carbon black and coke.

10. The method of claim 8, wherein said inorganic fluoride agent comprises cobalt trifluoride to form CₓF and CoF₂, wherein x comprises a value from 1 to 4.

11. The method of claim 10, further comprising separating said CₓF from said CoF₂ and said CoF₃ by:
digesting said CₓF, said CoF₂ and said CoF₃ in hot water causing said CoF₂ to dissolve in said hot water; and
removing said CoF₂.

12. The method of claim 11, wherein said CoF₃ is unreacted and undergoes hydrolysis in said hot water to form any of Co(OH)₃ and Co₂O₃.3H₂O, which is then washed with sulfuric acid to remove said CoF₃.

13. The method of claim 10, further comprising separating said CₓF from said CoF₂ and said CoF₃ by:
digesting said CₓF, said CoF₂ and said CoF₃ in heated sulfuric acid;
filtering the digested said CₓF, said CoF₂ and said CoF₃;
washing the filtered said CₓF, said CoF₂ and said CoF₃ with sulfuric acid; and
washing the filtered said CₓF said CoF₂ and said CoF₃ with hot water.

14. The method of claim 8, wherein the electrochemical cell is a lithium battery.

15. An electrochemical cell comprising carbon fluoride material, wherein said carbon fluoride material is synthesized without using fluorine gas by high intensity milling a carbon-containing material with an inorganic fluoride agent at ambient room temperature.

16. The electrochemical cell of claim 15, wherein said carbon-containing material comprises any of graphite, carbon black and coke.

17. The electrochemical cell of claim 15, wherein said inorganic fluoride agent comprises cobalt trifluoride.

18. The electrochemical cell of claim 17, wherein the synthesis of said carbon fluoride material occurs by separating said CₓF from said CoF₂ and said CoF₃ by:
digesting said CₓF said CoF₂ and said CoF₃ in hot water causing said CoF₂ to dissolve in said high temperature water; and
removing said CoF₂.

19. The electrochemical cell of claim 17, wherein said CₓF is separated from said CoF₂ and said CoF₃ by:
digesting said CₓF, said CoF₂ and said CoF₃ in heated sulfuric acid;
filtering the digested said CₓF, said CoF₂ and said CoF₃;
washing the filtered said CₓF, said CoF₂ and said CoF₃ with sulfuric acid; and
washing the filtered said CₓF, said CoF₂ and said CoF₃ with hot water.

20. The electrochemical cell of claim 15, wherein the electrochemical cell is a lithium battery.
